(19) United States
(12) Patent Application Publication
(10) Pub. No.: US 2021/0089422 A1
(43) Pub. Date: Mar. 25, 2021

(54) SYSTEM AND METHOD FOR SERVERLESS COMPUTING BASED ON BLOCKCHAIN

(71) Applicant: COMMON COMPUTER INC., Seoul (KR)

(72) Inventors: Min Hyun KIM, Seoul (KR); Dong Il SEO, Seoul (KR); Seong Hwa YUN, Seoul (KR); Young Soe YOO, Seoul (KR)

(21) Appl. No.: 17/012,925

(22) Filed: Sep. 4, 2020

Related U.S. Application Data
(60) Provisional application No. 62/928,538, filed on Oct. 31, 2019.

(30) Foreign Application Priority Data
Sep. 6, 2019 (KR) 10-2019-0110550

(51) Int. Cl. G06F 11/30; G06F 16/22

(52) U.S. Cl. CPC G06F 11/3079; G06F 2201/80; G06F 16/2246; G06F 11/3075

(57) ABSTRACT

The present disclosure provides a blockchain-based serverless computing system including a blockchain server configured to store and manage a database including a plurality of block states updated according to at least one transaction received from a client, a state listener configured to monitor whether or not the plurality of block states are changed, and a worker configured to execute a function according to the change of the plurality of block states, the state listener detects the change of the plurality of block states and notifies the worker of a function execution according to the change of the block states, and the worker executes the function according to the notification of the function execution. In addition, a transaction indicating the execution result of the functions by worker can be recorded on the blockchain network.

### CROSS-REFERENCE TO RELATED APPLICATION

This application claims priority under 35 U.S.C. § 119 to Korean Patent Application No. 10-2019-0110550, filed in the Korean Intellectual Property Office on Sep. 6, 2019, and U.S. Patent Application No. 62/928,538, the entire contents of which are hereby incorporated by reference.

### FIELD

The present disclosure relates to a blockchain-based serverless computing system and method, and more specifically, to a system and method capable of processing one or more operations in parallel by configuring such that the operations are started and executed by workers having a secure execution environment in an off-chain state, by setting or updating a block state value of a blockchain database.

### BACKGROUND

In general, blockchain technology refers to a technology that records and stores contents of transactions performed over a network communication in a reliable and secure way. A blockchain network is a system in a distributed environment in which the exchange of digitized assets or transactions are enabled, and, using a shared ledger, it records the history of electronic transactions or operations that occur in a peer-to-peer (P2P) network. Since the blockchain network uses a decentralized consensus mechanism, forgery and alteration of transactions by third parties is practically impossible, and this ensures the reliability and transparency of transactions.

For example, when Ethereum as one form of public blockchain is used, data security and reliability can be guaranteed by validating the code execution by the participating nodes in the blockchain. However, the current speed of Ethereum's consensus process stays at 15 transactions per second (TPS), which is not enough to handle the operation of applications distributed worldwide. In addition, structurally, considering the characteristics of statefulness, trustlessness, and serialized operation, the scalability of Ethereum may be considerably limited.

In recent years, serverless computing technology having characteristics of stateless, permissioned, and concurrent operation has been used to increase the scalability of applications. The serverless computing refers to an event-based cloud computing technology that enables development of the applications regardless of the consideration of computing resources required for the execution of the applications. In the serverless computing system, a cloud service provider, or a distributed resource provider dynamically allocates machine resources, and executes a code provided by an application developer through the allocated machine resources. In such a serverless computing environment, costs for infrastructure operation and maintenance can be reduced, service users can easily access the service network, and the time and cost required for code execution can be efficiently managed through data storage and various functions provided by the cloud service.

### SUMMARY

A conventional blockchain-based computing system supports a limited set of programming languages and one virtual machine that runs an application written in that programming language, and all nodes participating in the blockchain execute the same transaction. For this reason, there is a problem that it is impossible to call an external database and an application programming interface (API) because the operating cost of the entire system increases and the interactions occur only with the internal state database.

In order to solve the above problem, according to an exemplary embodiment, there is provided a blockchain-based serverless computing system capable of executing various programming languages on different types of runtime execution environments using a structure in which blockchain-based communication, repository, and execution (or calculation) are separated.

In addition, according to an exemplary embodiment, there is provided a blockchain-based serverless computing system capable of processing one or more operations in parallel by setting a path value (a block state) of the blockchain database and starting the operations, and recording the results for the operations in the designated paths by each resource provider.

In addition, according to an exemplary embodiment, there is provided a blockchain-based serverless computing system capable of configuring the block state of the blockchain database in a tree structure and defining different consensus rules for each partitioned sub-tree, and maintaining a small blockchain for each sub-tree.

The present disclosure provides a blockchain-based serverless computing system. This system may include a blockchain server configured to store and manage a database including a plurality of block states updated according to at least one transaction received from a client, a state listener configured to monitor whether or not the plurality of block states are changed, and a worker configured to execute a function according to the change of the plurality of block states, in which the state listener may detect the change of the plurality of block states and notify the worker of a function execution according to the change of the block states, and the worker may execute the function according to the notification of the function execution.

According to an embodiment, the blockchain server may set a permission to change the block states of the database, and set a function to be executed when the block states are changed.

According to an embodiment, the transaction may include a key-value pair including a target node path value (key) for operation and a target value of state update, and the block states may be configured in a tree structure reflecting the key-value pair of the transaction.

According to an embodiment, the blockchain server may configure the plurality of block states into a tree structure including a plurality of sub-trees, and apply different consensus rules to each of the sub-trees of the plurality of block states.

According to an embodiment, the system may apply a shard to each of the sub-trees of the plurality of block states, and the shard may process each of the sub-trees in a blockchain instance.

According to an embodiment, the transaction may include read_concern, and the read_concern may indicate a suitable point in time for utilizing the transaction including executing the worker based on the transaction. For example, when the read_concern is set to 0, it may indicate that the data of the transaction may be referenced even when the block generation based on the transaction is not executed, and when the read_concern is set to 1, it may indicate that the corresponding data may be referenced after block generation based on the transaction is executed at least once.

According to an embodiment, the blockchain server may further include a transaction pool that stores the transaction before the transaction is generated as a block, and the system may further include a first node configured to validate the transaction and reflect a result in the block state before storing the transaction in the transaction pool, and a second node configured to generate a block that includes the transaction by performing validation of the transaction stored in the transaction pool.

According to an embodiment, when the validation of the transaction and block generation are completed by the second node, the blockchain server may remove the transaction from the transaction pool.

According to another embodiment of the present disclosure, a blockchain-based serverless computing method is provided. The method may include updating, by a blockchain server, a block state of a database according to a transaction when at least one transaction is received from a client, monitoring, by a state listener, whether or not the block state is changed, notifying, by the state listener, a worker of a function execution according to a change of the blockchain state when detecting the change of the block state, and sending, by the worker, a transaction indicating a result of the worker executing the function to a blockchain network.

According to an embodiment, the blockchain-based serverless computing method may further include setting a permission to change the block state of the database, and setting a function to be executed when the block state is changed.

According to an embodiment, the updating, by the blockchain server, the block state of the database according to the transaction when at least one transaction is received from the client may include adding the transaction to a transaction pool before the transaction is generated as a block, validating, by a first node, the transaction and reflecting a result in the block state before the transaction is stored in the transaction pool, generating, by a second node, a block that includes the transaction by performing validation of the transaction stored in the transaction pool, and applying the block generated by the second node to the block state of the first node such that consistency of the blockchain network is maintained.

According to yet another embodiment, a computer readable storage medium storing one or more programs configured to be executed by one or more processors of a computing device is provided. The one or more programs may include instructions for performing the methods described above.

According to various embodiments of the present disclosure, in the blockchain-based serverless computing system, a structure in which communication, repository, and execution are separated is used, so that various programming languages can be supported in different runtime execution environments, and system operation costs can be reduced. In addition, according to embodiments of the present disclosure, in the blockchain-based serverless computing system, the block state of the blockchain database can be set to start and execute the operations, so that one or more operations can be processed in parallel, thereby increasing system performance.

Further, according to embodiments of the present disclosure, the block states of the blockchain database are configured in a tree structure to define different consensus rules for each sub-tree and maintain a small blockchain, so that the consensus rules can be set to meet the various requirements of the application running on the system (e.g., scalability, security, distribution, and the like).

When such a blockchain-based serverless system is used, it is possible to solve the problem of the conventional server-based computing where the user has to prepare a server, and then install and manage an operating system and necessary drivers and software. Accordingly, when the blockchain-based serverless system is used, the user may focus solely on writing the code of the application program.

The sharding may mean that the blockchain stores database state in a tree structure, which allows the database to be easily partitioned into multiple sub-trees. In this case, each partitioned sub-tree may define its own consensus method in addition to POS consensus, and maintain a small blockchain for each sub-tree. By defining the self-consensus method of the sub-tree, scalability, security, and distribution may be prioritized appropriately for each sub-tree.

### DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a diagram showing a configuration of a blockchain-based serverless computing system according to an exemplary embodiment;

FIG. 2 is a diagram showing an example of program codes and variables of rule configs according to an exemplary embodiment;

FIG. 3 is a diagram showing an example of a program code of owner configs according to an exemplary embodiment;

FIG. 4 is a diagram showing a configuration of registering a function by a client in the blockchain-based serverless computing system according to an exemplary embodiment;

FIG. 5 is a diagram showing a configuration of executing a function by a worker in the blockchain-based serverless computing system according to an exemplary embodiment;

FIG. 6 is a diagram showing a process in which a change of the blockchain state serves to trigger a chained-reaction between transaction generation and operation execution in the blockchain-based serverless computing system according to an exemplary embodiment;

FIG. 7 is a diagram showing a process of generating a transaction and a block in the blockchain-based serverless computing system according to an exemplary embodiment;

FIG. 8 is a diagram showing an example of transactions and subsequent change of the state according to an exemplary embodiment;

FIG. 9 is a diagram showing change of the state of a blockchain database according to read_concern according to an exemplary embodiment;

FIG. 10 is a diagram showing a sharding process through a sub-blockchain in the blockchain database according to an exemplary embodiment;

FIG. 11 is a flowchart showing a process of the blockchain-based serverless computing according to an exemplary embodiment; and

FIG. 12 is a flowchart showing a process of executing a transaction and generating a block according to an exemplary embodiment.

### DETAILED DESCRIPTION

Hereinafter, specific details for the practice of the present disclosure will be described in detail with reference to the accompanying drawings. However, in the following description, detailed descriptions of well-known functions or configurations will be omitted when it may make the subject matter of the present disclosure rather unclear.

In the accompanying drawings, the same or corresponding components are given the same reference numerals. In addition, in the following description of the embodiments, duplicate descriptions of the same or corresponding components may be omitted. However, even if descriptions of components are omitted, it is not intended that such components are not included in any embodiment.

In the present disclosure, the term “serverless computing” may mean a computing environment or system in which, unlike a conventional server-based computing in which users prepare a server and prepare an operating system and other necessary drivers and software to perform specific operations, a user does not need to manage a server or set its calculation and storage capacity. As described in detail below with reference to various embodiments, in the serverless computing system, a back-end code may be automatically executed in response to an event. Here, the code may be stored in a repository and executed in a managed environment of workers (i.e., execution environment or resource providers). When the serverless computing system is implemented based on a blockchain, the workers can provide an off-chain execution environment that is provided separately from the blockchain.

In the present disclosure, the term “PoW” or “Proof-of-Work” may refer to one of the consensus algorithms used for block generation in the blockchain network, such as a consensus algorithm that proves the validity of a transaction by calculating a nonce value of a block, for example. On the other hand, the term “PoS” or “Proof of Stake” may refer to a consensus algorithm that gives decision-making permission in proportion to the share ratio of the cryptocurrency or computing resource held by each node. For example, in a blockchain network using the PoS consensus algorithm, nodes that have assets such as cryptocurrency or the like may contribute to the generation of corresponding blocks by proving their ownership stake for the blocks they consensus on. The process of validating the validity of a block in the PoW-based blockchain is referred to as “mining”, whereas the corresponding process may be referred to as “forging” in the PoS-based blockchain.

Unlike the conventional blockchain system that includes all components of a smart contract in a blockchain network, the blockchain-based serverless computing system according to an exemplary embodiment has the system components partitioned and operated for repository, communication processing network, and calculation components. The blockchain-based serverless computing system according to the present embodiment serves to record the communication between components in the order of occurrence, and is configured such that calculation jobs may be executed in an off-chain state in a secure runtime environment (SRE). In this system, the repository may serve as an adapter to aggregate different repositories (e.g., Amazon S3, Google Cloud Storage, IPFS, and the like).

According to an embodiment, the blockchain-based serverless computing system may manage requests received from uploaded programs, resource providers and clients. In addition, in the blockchain-based serverless computing system, the execution of operations is stateless and asynchronous, which is different from the conventional blockchain systems (e.g., Ethereum) in which smart contract operations are recorded as state and contract calls cannot be executed in parallel. In other words, the system starts each operation or arithmetic operation by setting a path value or a block state in the blockchain database, and each worker executing this operation records the execution result in the designated path. As long as there is no attempt to redundantly change the specific path value in the blockchain database, all operations may be processed in parallel.

In addition, according to an embodiment, the blockchain-based serverless computing system may store a database state in a tree structure. As described above, by partitioning and configuring the database into multiple sub-trees, except for the genesis rule of the blockchain network (e.g., PoS rule), each partitioned sub-tree may define its own consensus algorithm and maintain a small blockchain for each sub-tree.

In an embodiment, the blockchain-based serverless computing system may serve as a backend system for running applications. In this system, the application may be run as follows. First, when a client (or decentralized application (dApp)) sends a transaction to the blockchain, the block state of the blockchain node is updated by the data of the corresponding transaction (e.g., path-value pairs). Meanwhile, while monitoring the blockchain path, the block state listener detects the updated state by the transaction and sends the event to the worker. The worker receiving the event may execute an operation or function related to the transaction and generate another transaction. When the worker generates another transaction, the block state of the blockchain node is updated by the corresponding transaction. In addition, the client may obtain the result through the modified blockchain state.

According to an embodiment, the types of blockchain state may include values type, rules type, owners type, and the like. For example, the values type may represent values in a database, and the rules type may represent database rules for determining a user who has permission to write values. In addition, the owners type may represent database owners to determine a user who has the ownership to change rules or ownerships. Each of the values type, the rules type, the owners type, and the like may be used at different root nodes in the internal key-value pair tree structure.

According to an embodiment, the blockchain state may be accessed using state access operations. For example, the state access operations may include read operations, write operations, and the like, and each operation may be classified into categories such as a simple operation, a composite operation, and the like. Here, the simple operation may mean the operation having one access reference point, while the composite operation may mean the operation having a plurality of access reference points.

According to an embodiment, the read operation may mean the operation that does not require permission, and simple operation of the read operation may include the operations described in Table 1 below.

TABLE 1

| Target | Operator | Parameters | Action |
|---|---|---|---|
| Value | GET_VALUE | ref | Get the value on |
| | | | the path reference |
| Rule | GET_RULE | ref | Get the rule on the |
| | | | path reference |
| Owner | GET_OWNER | ref | Get the owner on |
| | | | the path reference |
| Function | GET_FUNC | ref | Get a triggering |
| | | | function hash on |
| | | | the path reference |

In addition, the composite operation of the read operation may include the operations described in Table 2 below. Here, the composite operation of the read operation may require permission requirements for all paths.

TABLE 2

| Target | Operator | Parameters | Action |
|---|---|---|---|
| Value, | GET | op_list (list | Get multiple path- |
| rule | | of get | value, path-rule, |
| owner or | | operations) | path-owner or path- |
| function | | | function pairs |

According to an embodiment, each write operation may include a permission requirement according to the type of the blockchain state and a path reference, and the simple operation of the write operation may include the operations described in Table 3 below. Here, each operation may require a write permission requirement for the path.

TABLE 3

| Target | Operator | Parameters | Action |
|---|---|---|---|
| Value | GET_VALUE | ref, value | Set the value on |
| | | | the path reference |
| Value | INC_VALUE | ref, value | Increment the value |
| | | | on the path reference |
| Value | DEC_VALUE | ref, value | Decrement the value |
| | | | on the path reference |
| Rule | GET_RULE | ref, rule | Set the rule on the |
| | | | path reference |
| Owner | GET_OWNER | ref, owner | Set the owner on |
| | | | the path reference |
| Function | GET_FUNC | ref, | Set a triggering |
| | | funcHash | function on the |
| | | | path reference |

In addition, the composite operation of the write operation may include the operations described in Table 4 below.

TABLE 4

| Target | Operator | Parameters | Action |
|---|---|---|---|
| Value, | SET | op_list (an | Set multiple path- |
| rule, | | array of | value, path-rule, |
| owner | | operations) | path-owner or path- |
| or | | | function pairs |
| function | BATCH | tx_list (an | Handle each |
| | | array of | transaction |
| | | transactions) | independently |

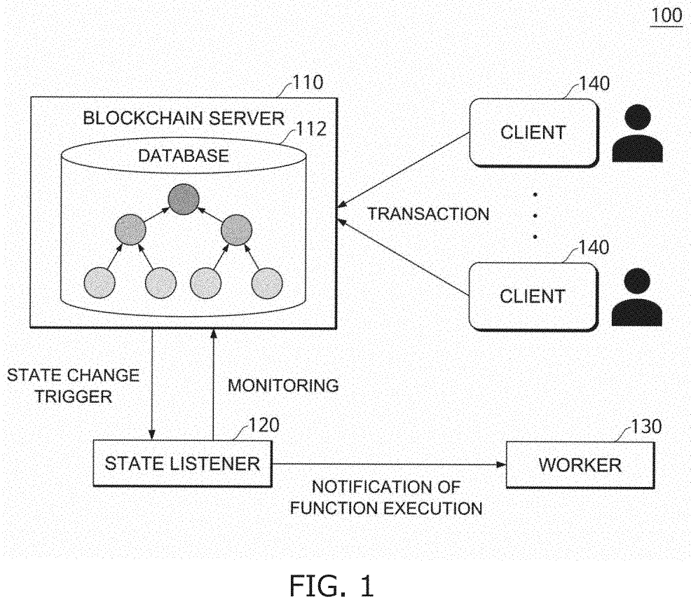

FIG. 1 is a diagram showing the configuration of a blockchain-based serverless computing system according to an exemplary embodiment. The blockchain-based serverless computing system 100 includes a blockchain server 110 that stores and manages a database including a plurality of block states, a state listener 120 that monitors whether the block state is changed, and a worker 130 that executes a function according to the change of the block state.

As shown, the blockchain server (or node) 110 may include a database 112 including a plurality of block states. In an embodiment, each block state stored in the database 112 may include a balance of each public key and a key-value database. The block state may be one of two types: master state and rule state. The master state may store actual data updated by all participating nodes in the blockchain network. In addition, the rule state may include a rule for determining access permission to change a data value corresponding to the key.

In addition, the database 112 may be configured in a tree structure. The database 112 configured in a tree structure may maintain a subset (or sub-tree) of a tree as a shard by applying a sharding technique. In the present disclosure, “sharding” may refer to an on-chain solution that provides scalability to the blockchain by partitioning the entire blockchain network and storing the transactions per section and processing them in parallel. Since each sub-tree managed with the shard is processed in a separate small blockchain instance, the effect of greatly increased total throughput of the blockchain can be provided. In an embodiment, it may be established such that different PoS consensus algorithms are applied to each sub-tree of the database 112.

The state listener 120 may monitor whether the block state of the blockchain stored in the database 112 is changed. In an embodiment, after the worker 130 is set to execute a new operation, the state listener 120 may be registered and installed in the worker 130 as a module generated or executed by the worker 130 or may be registered and installed in the blockchain server 110.

The blockchain server 110 may set the permission to change the block state of the database 112, and may set a function to be executed when a transaction is received from one or more clients (or dApps) 140 and changes the block state. In addition, when receiving a transaction from one or more clients (or dApps) 140, the blockchain server 110 may change the blockchain block state according to the transaction, and the state listener 120 may monitor the blockchain server 110 to detect a change of the block state. When the state listener 120 detects a change of the block state, it may notify the worker 130 of the execution of a function according to the change of the block state. In an embodiment, the worker 130 may generate another transaction as a result of executing the function according to the change of the block state. In this case, the worker 130 may send the newly generated transaction to the blockchain server 110 and update the block state. Such an update of the block state in the blockchain server 110 may cause a chained-reaction leading to the execution of additional operations. That is, when the transaction generated by the worker is sent to the blockchain server 110 and the block state is updated, the state listener 120 may detect the state update and notify the worker 130 or another worker of the execution of the related operation.

In an embodiment, the blockchain server 110 and the worker 130 described above may be included in one node of the blockchain network. In this case, the blockchain server 110 and the worker 130 may immediately execute a related operation in response to the received transaction. In another embodiment, the worker 130 may be implemented to be detachable from the blockchain server 110 and may be hosted by another computing device (or resource provider). In this case, a separate communication channel from the computing device to the blockchain server 110 may be formed.

When such a blockchain-based serverless system is used, it is possible to solve the problem of the conventional server-based computing where the user has to prepare a server, and then install and manage an operating system and necessary drivers and software. Accordingly, when the blockchain-based serverless system is used, the user may focus solely on writing the code of the application program.

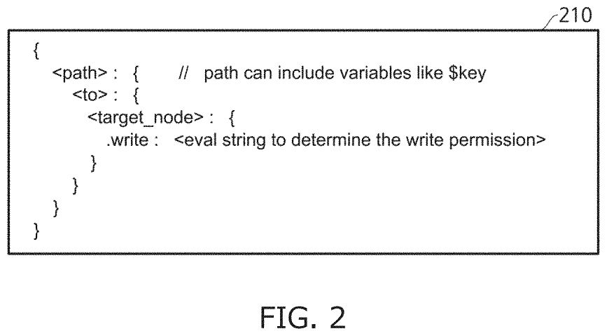

FIG. 2 is a diagram showing an example of a program code 210 of rule configs according to an exemplary embodiment. According to an embodiment, the rule configs may be used to determine the validity of a corresponding transaction before the transaction is executed. In other words, the blockchain server may use the rule configs to validate the validity of the transaction generated from the client. Further, the rule configs may be used to control clients that can perform certain types of transactions. For example, the rule values may be a JavaScript Boolean statement or the like that is called whenever a client tries to write data to the blockchain database. Such a Boolean statement may be evaluated as true or false by the blockchain nodes who execute the Boolean statement for the new data with the current blockchain state.

According to an embodiment, the rule configs may be used when executing the agreed contract conditions between nodes on the network, or may be used to ensure automatic payment of related nodes when the contract conditions are satisfied and all transactions related to the contract are added to the blockchain. Additionally or alternatively, the rule configs may be used to determine a client who has permission to build and validate blocks on the blockchain, or may be used to punish clients that compromise the integrity of the blockchain.

According to an embodiment, the program code 210 of the rule configs may be stored as a “write” property on a path of the database using a “SET_RULE” operation. For example, the value of the program code 210 may be a JavaScript string that can be evaluated as true or false to determine the permission of the client on the path whenever a transaction with a value write operation on the path is submitted.

Meanwhile, the variables of the rule configs may include path variables for allowing flexibility of rule expressions, and may include built-in variables provided by the system. Meanwhile, data access may not require read permission. Accordingly, all network participants may read the data. In this case, the client may encrypt the data with its own private key in order to protect the data of a specific node path.

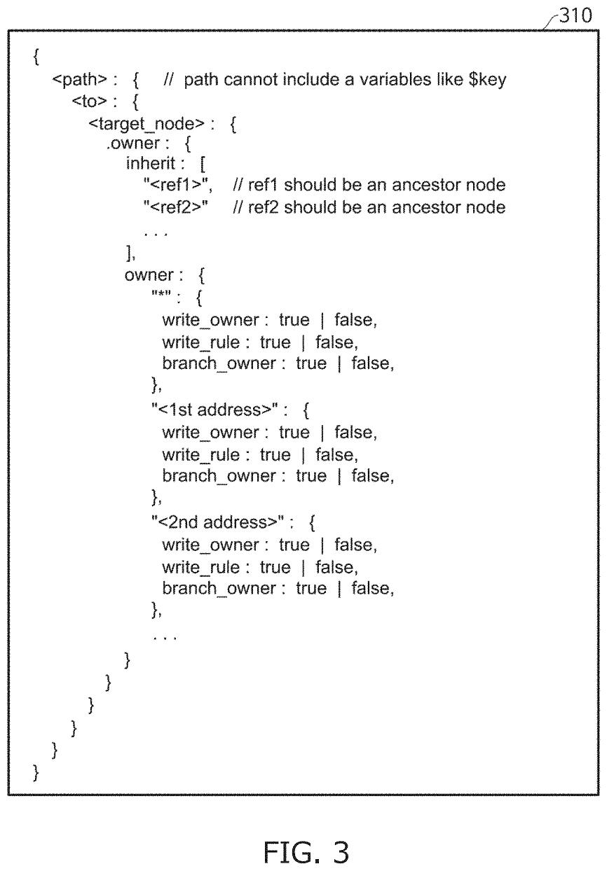

FIG. 3 is a diagram showing an example of a program code 310 of owner configs according to an exemplary embodiment. According to an embodiment, the owner configs may be used to control write permission on the rule configs. 1n addition, the owner configs may be used to control write permission on the owner configs. In other words, blockchain servers may use the owner configs to control permission of the client.

According to an embodiment, the program code 310 of the owner configs may be stored in the path of the database as the “owner” property using a “SET_OWNER” operation. For example, in the program code 310, ‘write-owner’ may indicate the user property of the owner configs, and when the value of ‘write-owner’ is true, the client may write the owner configs itself. In addition, in the program code 310, ‘write-rule’ may indicate the user property of the owner configs, and when the value of ‘write-rule’ is true, the client may write the rule configs. Additionally, in the program code 310, “branch-owner” may indicate the user property of the owner configs, and when the value of “branch-owner” is true, the client may add the branch owner configs. Additionally, in the program code 310, ‘inherit’ may indicate the user property of the owner configs, and a value of ‘inherit’ may be provided as an array of paths to the owner configs. Here, when the value of ‘inherit’ is set, an owners list corresponding to the specified path may be included in the corresponding owners list.

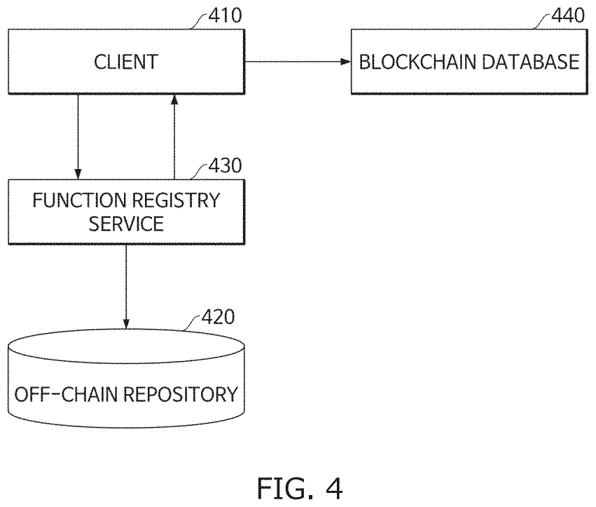

FIG. 4 is a diagram showing a configuration of registering a function by a client 410 in the blockchain-based serverless computing system according to an exemplary embodiment.

In an embodiment, an application running on a blockchain-based serverless computing system may use a function to execute a backend-code in response to a blockchain event. The codes may be stored in an off-chain repository and executed in runtime environment of a worker operated by various resource providers.

Unlike the conventional blockchain network in which smart contract operations are synchronous and sequentially executed, the functions of the present disclosure may be executed asynchronously and in parallel. Data used for the function may be transferred from the blockchain state, and the execution result of the function may be transferred back to the blockchain state. Since the function does not record any internal state during its execution, each function call may be said to be independent and stateless.

As shown, the blockchain-based serverless computing system provides a function registry service 430 such that the client 410 can upload a function program to the off-chain repository 420. The function uploaded to the repository 420 may be accessed as a hash value of the corresponding function, such as function_hash, for example, and a corresponding path and function may be bound by a transaction that sets function_hash in the trigger_path of the blockchain state, for example. The function may be executed by setting a parameter of the corresponding function in the block state of the blockchain database 440, and each worker may record the execution result of the function in a designated state path. The path for the parameters and execution result may have an associated rule to control the permission for calling the corresponding function and recording the execution result of the function.

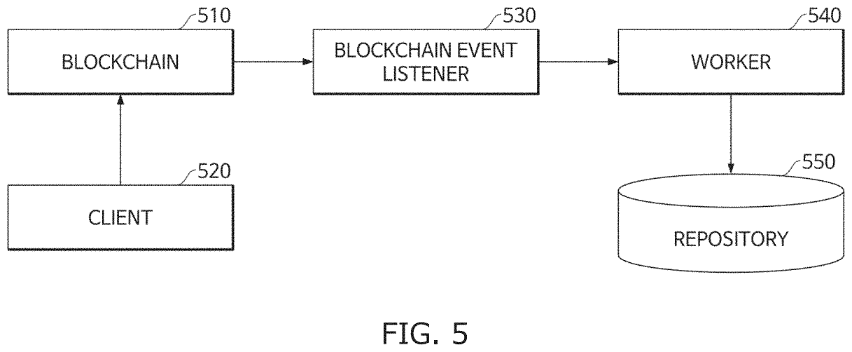

FIG. 5 is a diagram showing a configuration of executing a function by a worker in the blockchain-based serverless computing system according to an exemplary embodiment;

As shown, when the blockchain 510 receives from the client 520 a transaction for setting a path and parameter associated with the function, the block state is updated by the corresponding transaction. At this time, the blockchain event listener 530 may monitor the change of the block state and send the event to the corresponding worker 540.

As described above, the triggered worker 540 may download from the repository 550 the corresponding function based on the hash value and execute the same. In addition, the worker 540 may generate a new transaction as an execution result of the function. The additional transaction generated by the worker 540 may again update the block state and may trigger another worker for the corresponding event.

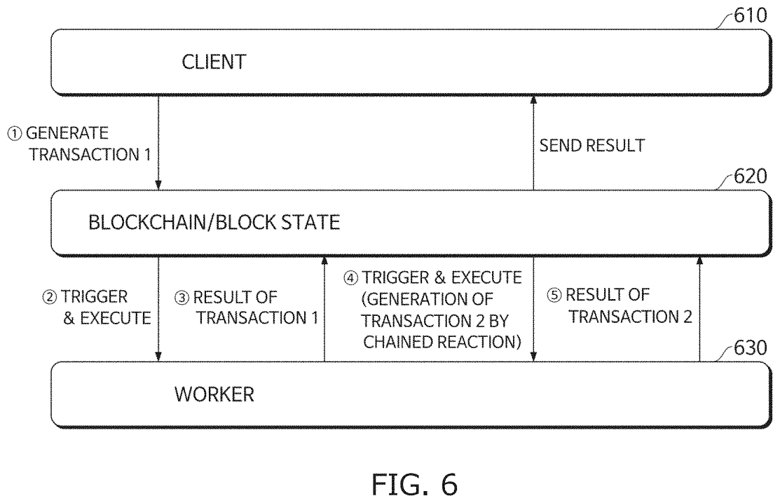

FIG. 6 is a diagram showing a process in which a change of the block state serves to trigger a chained-reaction between transaction generation and operation execution in the blockchain-based serverless computing system according to an exemplary embodiment.

As shown, the chained-reaction between the generation of a transaction and the execution of an operation may start with the client 610 generating the transaction through dApp, for example, and sending it to the blockchain server 620.

When the blockchain server 620 receives the transaction, the block state may be updated by the transaction. At this time, the state listener may monitor the change of the block state of the blockchain server 620 and send an event according to the change of the block state to the worker 630. The worker 630 may execute the operation or function triggered by the change of the block state as described above, and may generate an additional transaction as a result of the execution of the function. The additional transaction generated by the worker 630 may be sent to the blockchain server 620 again, and accordingly, the corresponding block state may be updated. In this case, the updated state change may cause an operation of another worker to be executed. In addition, the client 610 may obtain a result value through the updated block state of the blockchain.

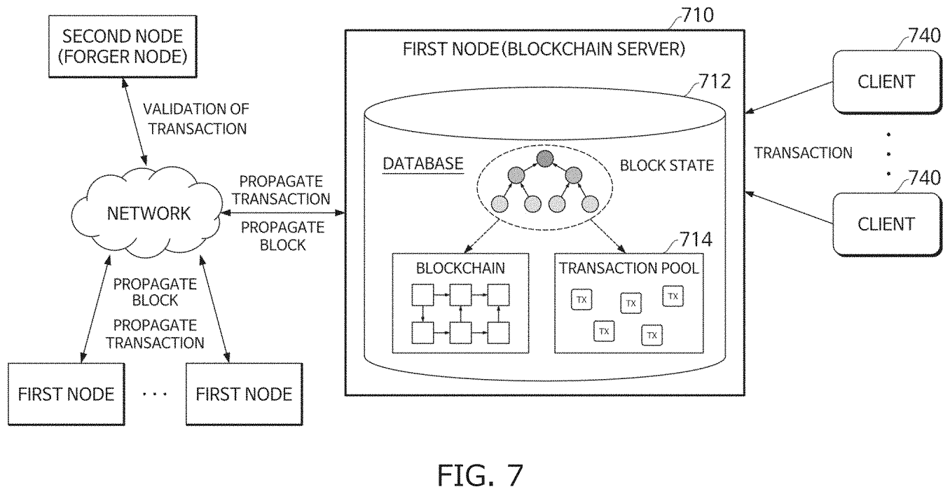

FIG. 7 is a diagram showing a process of generating a transaction and a block in a blockchain-based serverless computing system according to an exemplary embodiment. The blockchain server 710 and the database 712 shown in FIG. 7 may include the blockchain server 110 and the database 112 shown in FIG. 1, respectively.

In an embodiment, a plurality of first nodes (or blockchain servers) and second nodes may form a blockchain network. In addition, the first node (or blockchain server) 710 may include a database 712 including the block state of the blockchain, and a transaction pool 714. The state of the database 712 is determined by the total set of transactions added to blocks of the blockchain and all valid transactions in the transaction pool 714 that have not yet been added to the blocks. This state may include information on which subsequent transactions are allowed, as well as on all previous transactions and blocks that have occurred up to the current state.

The client 740 may generate a transaction to update the block state stored and managed by the blockchain server 710. Each transaction includes a transaction identifier, an address (e.g., a public key of the transaction owner), and data specifying an actual state update request (e.g., a key-value pair including a target node path (key) for an operation and a target value (value) of state update).

Upon receiving the transaction sent from the client 740, the blockchain server 710 may store the corresponding transaction in the transaction pool 714. The transaction pool 714 may refer to a repository of valid transactions that have not yet been added to the block, but are part of the consensus blockchain.

In an embodiment, a node (or first node) including the blockchain server 710 may validate and execute the transaction before the transaction is stored in the transaction pool 714. The first node may validate the corresponding transaction using a signature that ensures that the transaction has been sent by the appropriate client 740 and a rule to check if the transaction violates the permission. In addition, the first node may complete execution of the transaction (or application to the database) by updating the transaction data (e.g., path-value pairs) to the block state of the database 712. As will be described in detail below, whether or not to update the transaction data in the block state or not may be determined by a value indicating the reliability of data included in the transaction. When the transaction is added to the transaction pool 714 by the first node, that transaction may be propagated through the network until all other nodes on the blockchain network add the transaction to the local transaction pool.

In an embodiment, a “flood routing” protocol may be used such that transactions are propagated quickly and efficiently in the blockchain network. When transactions are validated and propagated according to this protocol, each node of the blockchain network may act as a co-equal node of the P2P network. The co-equal nodes as described above form a mesh network, so that all nodes on the network are always maintained in a state of being connected to other nodes. Each node of the blockchain network having such a configuration may receive and propagate transactions with each neighboring node.

In an embodiment, the transaction propagation may be initiated at an originating node that has generated the transaction or received the transaction from the client 740. The originating node may validate the transaction by performing the following steps. That is, the corresponding node may check the local transaction pool 714 and the blockchain to confirm that the transaction is not duplicated, check whether the signature included in the transaction matches the public key of the transaction sender, validate the nonce to confirm that the transaction is not breaking the dependency on other transactions, and check if output of the transaction determined by the blockchain rules of the blockchain network is valid. Through these steps, if the transaction is determined to be valid, the transaction may be executed immediately, the originating node propagates the transaction to neighboring nodes, and the neighboring nodes repeatedly perform the same validation and propagation processes.

Meanwhile, a forger node (or second node) of the blockchain network may perform validation (or forging) of the transaction added to the transaction pool 714. In addition, the second node may generate a block including a transaction that has been validated and connect it to the blockchain. The block connected to the blockchain is propagated to the first nodes forming the blockchain network, and all nodes are updated to have the same blockchain state.

When the verification and block generation for the transaction are completed and the transaction is added to the blockchain, the transaction is removed from the transaction pool 714. The transaction removed from the transaction pool and added to the blockchain may be maintained in the same state across all nodes.

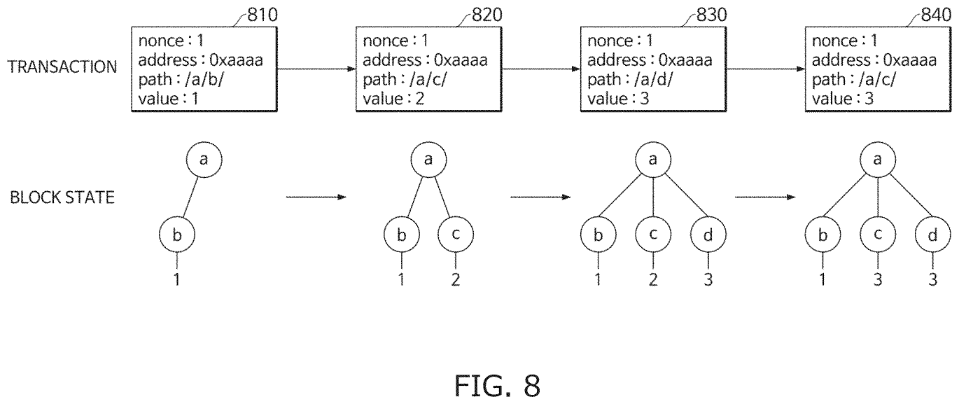

FIG. 8 is a diagram showing an example of transactions and subsequent change of the state according to an exemplary embodiment;

In an embodiment, the transaction newly generated in the blockchain-based serverless computing system may be constructed while newly updating the state of the blockchain database generated or updated by the previous transaction. A unique identifier is automatically assigned to the newly generated transaction request, and a nonce increased by +1 from the previous transaction may be assigned.

For example, as shown, the transaction 810 is assigned a nonce ‘1’ and an address 0xaaaa. In addition, the transaction 810 may trigger to set value ‘1’ to the state path ‘/a/b/’.

A new transaction 820 is then generated, and the transaction may trigger to set value ‘2’ in the state path ‘/a/c/’. In addition, a subsequently generated transaction 830 may trigger to set value ‘3’ to the state path ‘/a/d/’, and the transaction 840 may trigger to set value ‘3’ to the state path ‘/a/c/’.

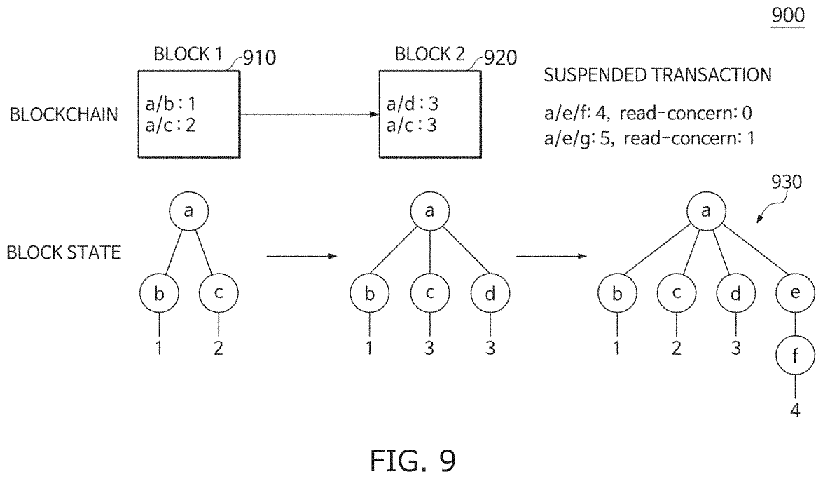

FIG. 9 is a diagram showing a state change of a blockchain database according to read_concern according to an exemplary embodiment. The database 900 shown in FIG. 9 may represent a detailed configuration of the databases 112 and 712 stored and managed by the blockchain servers 110 and 710 of the blockchain-based serverless computing system described with reference to FIGS. 1 and 7.

As shown, the database 900 may include blocks 910 and 920 including transactions and block states 930 corresponding thereto. For example, the block 910 is generated to include transactions “a/b: 1” and “a/c: 2”, and correspondingly, the block state 930 is updated to reflect value “1” in the path “a/b” and reflect value “2” in the path “a/c”. Next, the block 920 is generated to include transactions “a/d: 3” and “a/c: 3”, and correspondingly, the block state 930 maintains value “1” in the path “a/b”, and is updated such that the value of the path “a/c” is changed from “2” to “3” and value “3” is reflect in the path “a/d”.

Meanwhile, in the transaction pool of the blockchain server, transactions (“a/e/f: 4”, “a/e/g: 5”) that have not yet been added as blocks to the blockchain are stored. These transactions may further include read_concern field in addition to the path (key)-value pair. The read_concern is a value that may be included when generating a transaction, and may indicate whether the data of the corresponding transaction is reliable enough to be reflected in the block state of the blockchain. In an embodiment, the transaction may designate read_concern to indicate a recommended block confirmation indicating the reliability of the value. The value of the read_concern may be 0 or 1 or more. For example, in the case of an application program that requires immediate execution of the transaction, the value of the read_concern may be 0.

In an embodiment, when the client generates a transaction, it may include information on the read_concern in the transaction, and the value may be arbitrarily set by the client. The first node of the blockchain server may reflect the key-value pair of the transaction in the block state based on the value of the read_concern of each transaction. For example, if the value of the read_concern is 0, based on a determination that the reliability is high enough to be used even before the block including the data of the corresponding transaction is generated, the data of the corresponding transaction may be immediately reflected in the block state of the database. In other words, the blockchain server may immediately execute the transaction if the value of the transaction read_concern is 0. On the other hand, if the value of the read_concern is 1 or more, the execution of the transaction may be suspended until there is one or more generations of the block including the data of the transaction.

In the example of FIG. 9, since the value of the read_concern of the transaction “a/e/g: 5” is assigned as 1 and is recommended to be read after a block is generated one time, the execution may be suspended without reflecting the data in the block state 930. On the other hand, since the value of the read_concern of the transaction “a/e/f:4” is assigned as 0, the transaction is immediately executed and reflected in the block state 930.

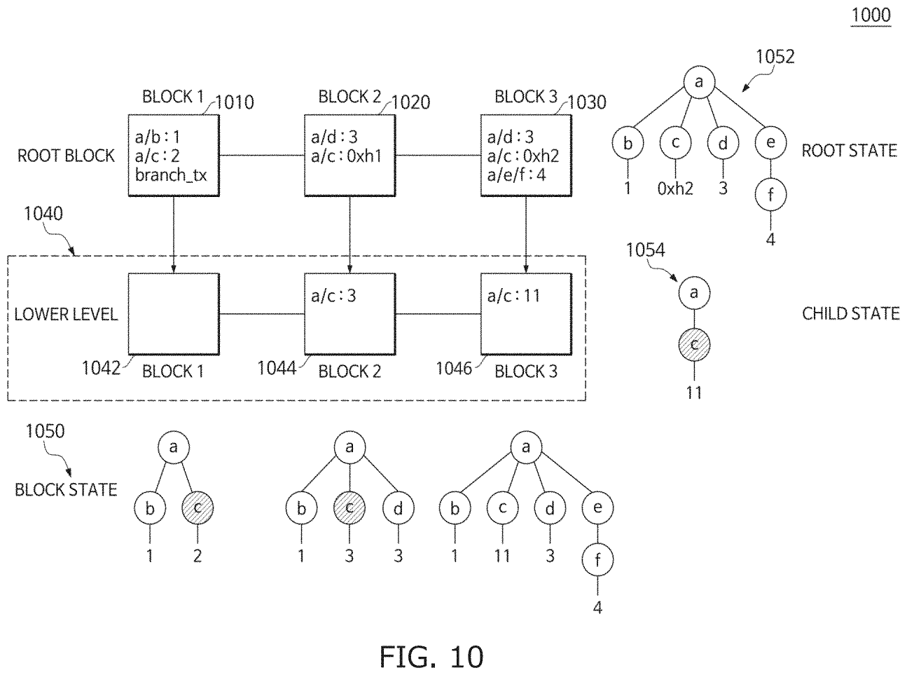

FIG. 10 is a diagram showing a sharding process through a sub-blockchain in the blockchain database according to an exemplary embodiment. The database 1000 shown in FIG. 10 may represent a detailed configuration of the databases 112 and 712 stored and managed by the blockchain servers 110 and 710 of the blockchain-based serverless computing system described with reference to FIGS. 1 and 7.

The database 1000 may include a chain of blocks 1010, 1020, 1030, 1042, 1044, and 1046 having a plurality of levels. In addition, the database 1000 may further include block states 1050, 1052, and 1054 that reflect path (key)-value pairs of transactions included in the blocks 1010, 1020, and 1030.

As shown, the database 1000 may include root blocks 1010, 1020, and 1030 that use the highest-level rule, and lower-level child blocks 1042, 1044, and 1046 generated by branching from these blocks. The path-value pairs of transactions included in the root blocks 1010, 1020, and 1030 are reflected in the root state 1052 and stored, and the path-value pairs of the child blocks 1042, 1044, and 1046 are reflected in the child state 1054 and stored. In addition, the root state 1052 and the child state 1054 may be integrated and displayed as an overall state 1050.

In an embodiment, block states of the database 1000 may be managed using a sharding method. Overall, the block states are configured in a tree structure, and some of the block states (that is, sub-trees) of this tree structure may be maintained and managed by one shard. In the embodiment of FIG. 10, the child state 1054 among all states 1050 may be managed as one shard. Accordingly, blocks 1042, 1044, and 1046 of the lower level 1040 corresponding to the child state 1054 may also be managed as shards. A shard configured in this way may perform validation of blocks belonging to it. In general, the PoW (Proof of Work) consensus method may be difficult to apply to a blockchain managed by sharding because the amount of calculation required for attacking or hacking each shard is significantly smaller than the amount of calculation required to attack all blocks. Therefore, the PoS consensus method may be used for each shard in this embodiment. In an embodiment, the sharding may mean that the blockchain stores the database state in a tree structure, which allows the database to be easily partitioned into multiple sub-trees. In this case, each partitioned sub-tree may define its own consensus method in addition to POS consensus, and maintain a small blockchain for each sub-tree. By defining the self-consensus method of the sub-tree, scalability, security, and distribution may be prioritized appropriately for each sub-tree.

In an embodiment, the highest-level consensus rules may be applied to the root blocks 1010, 1020, and 1030, and the highest level consensus rules may be stored in the block 1010 located at the forefront of the chain of root blocks. In addition, its own consensus rule may be applied to blocks corresponding to sub-trees of block states managed by shards, respectively. As such, the consensus rules applied to the sub-tree of block states may be stored in the block 1042 located at the forefront in the chain of child blocks 1042, 1044, and 1046.

As described above, by setting different consensus rules for each sub-tree of block states (e.g., child state 1054), the problem of scalability Trilemma may be solved. That is, the blockchain-based serverless computing system of the present disclosure may set various consensus rules to satisfy the requirements for scalability and security of various types of applications. For example, when an application requires scalability, the simple PoS consensus rule may be used to maximize throughput, and when the application requires strong security, the permissionless PoS rule may be used, and when the application requires more decentralization, a new consensus rule may be adopted and applied.

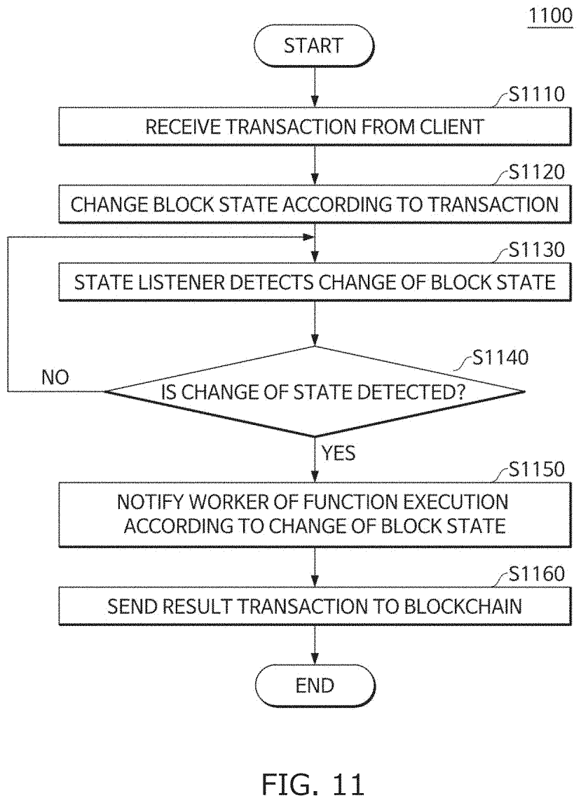

FIG. 11 is a flowchart showing a process of a blockchain-based serverless computing according to an exemplary embodiment. The process 1100 may start at the blockchain server which receives the transactions from one or more clients, at S1110.

The clients (or dApps) may generate the transactions, and the corresponding transactions may be sent to a blockchain server and stored in a database. In addition, the blockchain server may set the permission to change the block state of the database, and set the function to be executed when the block state is changed. When the transactions are received from one or more clients, the blockchain server changes the block state of the database according to the corresponding transactions, at S1120. The transaction data may include a path (key)-value pair, and the block state reflecting the transaction may be configured in a tree structure.

Next, the state listener detects a change of the block state, at S1130. The state listener monitors the blockchain server and determines whether the block state is changed, at S1140. When detecting the change of the block state, the state listener notifies the worker of the function execution according to the change of the blockchain state, at S1150. The state listener sends an event (or trigger) according to the change of the block state to the worker, and the worker executes a function according to the change of the block state according to the received event.

A transaction indicating the execution result of the function of the worker may be sent to the blockchain server, at S1160. The worker may generate an additional transaction as a result of the function execution. The additional transaction generated by the worker may be updated back to the block state stored in the database of the blockchain server, and the client obtains the result through the change of the blockchain state.

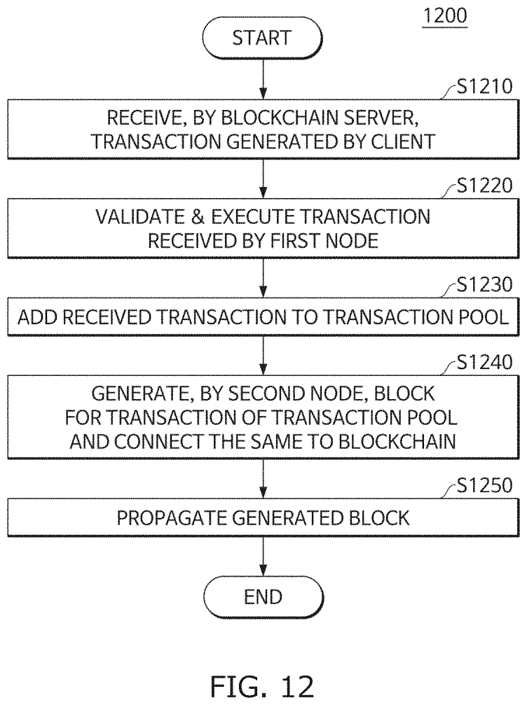

FIG. 12 is a flowchart showing a process of executing a transaction and generating a block according to an exemplary embodiment. The process 1200 of executing a transaction and generating a block starts at the blockchain server which receives the transaction generated by the client, at S1210.

The blockchain server may include a database including the block state and the transaction pool for storing transactions. When the blockchain server receives the transaction, by the first node, the transaction is validated and executed, at S1220.

The first node may validate and execute the transaction before the transaction is added to the transaction pool. To this end, the first node may validate the transaction by using a signature that ensures that the transaction has been sent by the client and a rule to check if the transaction violates the permission. Further, the first node may complete execution of the transaction by updating the transaction data (e.g., path-value pair) to the block state. Whether or not to update the transaction data in the block state may be determined by a value indicating the reliability of data included in the transaction.

When the validation and execution of the transaction are completed, the transaction is added to the transaction pool, at S1230. Thereafter, the second node generates a block for the transaction of the transaction pool and connects it to the blockchain, at S1240. The second node performs validation of the transaction received from the transaction pool, generates a block including the transaction, and connects the block to the blockchain. The second node propagates the generated block to the first nodes in the blockchain network, at S1250. Based on the propagated block, the first nodes compare the current state with their own states, and if there is an inconsistent state, correct it based on the block.

The components and methods of the apparatus or system described above may be implemented as computer readable codes in a computer readable recording medium. The computer readable recording medium includes all kinds of recording devices in which data readable by a computer system is stored. Examples of computer readable recording medium include ROM, RAM, CD-ROM, magnetic tape, floppy disks, and optical data storage devices, and the like. In addition, the computer readable recording medium may be distributed over network coupled computer systems so that the computer readable code is stored and executed in a distributed manner. Further, programmers in the technical field pertinent to the present disclosure will be easily able to envision functional programs, codes and code segments to implement the embodiments.

The techniques described herein may be implemented by various means. For example, these techniques may be implemented in hardware, firmware, software, or a combination thereof. Those skilled in the art will further appreciate that the various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design constraints imposed on the particular application and the overall system. Those skilled in the art may implement the described functions in varying ways for each particular application, but such decisions for implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described herein, computer, or a combination thereof.

Accordingly, various example logic blocks, modules, and circuits described in connection with the disclosure herein may be implemented or performed with general purpose processors, DSPs, ASICs, FPGAs or other programmable logic devices, discrete gate or transistor logic, discrete hardware components, or any combination of those designed to perform the functions described herein. A general purpose processor may be a microprocessor, but in the alternative, the processor may be any conventional processor, controller, microcontroller, or state machine. The processor may also be implemented as a combination of computing devices, for example, a DSP and microprocessor, a plurality of microprocessors, one or more microprocessors associated with a DSP core, or any other combination of such configurations.

In the implementation using firmware and/or software, the techniques may be implemented with instructions stored on a computer readable medium, such as random access memory (RAM), read-only memory (ROM), non-volatile random access memory (NVRAM), programmable read-only memory (PROM), erasable programmable read-only memory (EPROM), electrically erasable PROM (EPMROM), flash memory, compact disc (CD), magnetic or optical data storage devices, and the like. The instructions may be executable by one or more processors, and may cause the processor(s) to perform certain aspects of the functions described herein.

When implemented in software, the functions may be stored on a computer readable medium as one or more instructions or codes, or may be sent through a computer readable medium. The computer readable medium includes both the computer storage media and the communication media including any medium that facilitate the transfer of a computer program from one place to another. The storage media may also be any available media that may be accessed by a computer. By way of non-limiting example, such computer readable media may include RAM, ROM, EEPROM, CD-ROM or other optical disk storage, magnetic disk storage or other magnetic storage devices, or any other media that can be used to transfer or store desired program code in the form of instructions or data structures and can be accessed by a computer. Also, any connection is properly referred to as a computer readable medium.

For example, when the software is transmitted from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of computer readable media.

The software module may reside in RAM memory, flash memory, ROM memory, EPROM memory, EEPROM memory, registers, hard disk, removable disk, CD-ROM, or any other form of storage medium known. An exemplary storage medium may be coupled to the processor, such that the processor may read information from or write information to the storage medium. Alternatively, the storage medium may be integrated into the processor. The processor and storage medium may exist in the ASIC. The ASIC may exist in the user terminal. Alternatively, the processor and the storage medium may exist as separate components in the user terminal.

The above description of the present disclosure is provided to enable those skilled in the art to make or use the present disclosure. Various modifications of the present disclosure will be readily apparent to those skilled in the art, and the general principles defined herein may be applied to various modifications without departing from the spirit or scope of the present disclosure. Thus, the present disclosure is not intended to be limited to the examples described herein but is intended to be accorded the broadest scope consistent with the principles and novel features disclosed herein.

Although example implementations may refer to utilizing aspects of the presently disclosed subject matter in the context of one or more standalone computer systems, the subject matter is not so limited, and they may be implemented in conjunction with any computing environment, such as a network or distributed computing environment. Furthermore, aspects of the presently disclosed subject matter may be implemented in or across a plurality of processing chips or devices, and storage may be similarly influenced across a plurality of devices. Such devices may include PCs, network servers, and handheld devices.

Although the subject matter has been described in language specific to structural features and/or methodological acts, it will be understood that the subject matter defined in the appended claims is not necessarily limited to the specific features or acts described above. Rather, the specific features and acts described above are described as example forms of implementing the claims.

Although the method mentioned herein has been described through specific embodiments, it is possible to implement it as computer readable code on a computer readable recording medium. The computer readable recording medium includes all kinds of recording devices in which data readable by a computer system is stored. Examples of computer readable recording medium include ROM, RAM, CD-ROM, magnetic tape, floppy disks, and optical data storage devices, and the like. In addition, the computer readable recording medium may be distributed over network coupled computer systems so that the computer readable code is stored and executed in a distributed manner. Further, programmers in the technical field pertinent to the present disclosure will be easily able to envision functional programs, codes and code segments to implement the embodiments.

Although the present disclosure has been described in connection with some embodiments herein, it should be understood that various modifications and changes can be made without departing from the scope of the present disclosure, which can be understood by those skilled in the art to which the present invention pertains. In addition, such modifications and changes should be considered within the scope of the claims appended herein.

What is claimed is:

1. A blockchain-based serverless computing system, comprising:
a blockchain server configured to store and manage a database including a plurality of block states updated according to at least one transaction received from a client;
a state listener configured to monitor whether or not the plurality of block states are changed; and
a worker configured to execute a function according to the change of the plurality of block states,
wherein the state listener detects the change of the plurality of block states and notifies the worker of a function execution according to the change of the block states, and the worker executes the function according to the notification of the function execution.

2. The blockchain-based serverless computing system according to claim 1, wherein the blockchain server sets a permission to change the block states of the database, and sets a function to be executed when the block states are changed.

3. The blockchain-based serverless computing system according to claim 1,
wherein the transaction includes a key-value pair including a target node path value (key) for operation and a target value of state update, and
the block states are configured in a tree structure reflecting the key-value pair of the transaction.

4. The blockchain-based serverless computing system according to claim 1,
wherein the blockchain server configures the plurality of block states into a tree structure including a plurality of sub-trees, and
applies different consensus rules to each of the sub-trees of the plurality of block states.

5. The blockchain-based serverless computing system according to claim 4 applying a shard to each of the sub-trees of the plurality of block states,
wherein the shard processes each of the sub-trees in a blockchain instance.

6. The blockchain-based serverless computing system according to claim 1,
wherein the transaction includes read_concern, and
the read_concern indicates a suitable point in time for utilizing the transaction including executing the worker, based on the transaction.

7. The blockchain-based serverless computing system according to claim 1,
wherein the blockchain server further includes a transaction pool that stores the transaction before the transaction is generated as a block, and
the system further includes:
a first node configured to validate the transaction and reflect a result in the block state before storing the transaction in the transaction pool; and
a second node configured to generate a block that includes the transaction by performing validation of the transaction stored in the transaction pool.

8. A blockchain-based serverless computing method, comprising:
updating, by a blockchain server, a block state of a database according to a transaction when at least one transaction is received from a client;
monitoring, by a state listener, whether or not the block state is changed;
notifying, by the state listener, a worker of a function execution according to a change of the blockchain state when detecting the change of the block state; and
sending, by the worker, a transaction indicating a result of the worker executing the function to a blockchain network.

9. The blockchain-based serverless computing method according to claim 8, further comprising setting, by the blockchain server, a permission to change the block state of the database, and setting a function to be executed when the block state is changed.

10. The blockchain-based serverless computing method according to claim 8,
wherein the updating, by the blockchain server, the block state of the database according to the transaction when at least one transaction is received from the client includes:
adding the transaction to a transaction pool before the transaction is generated as a block;
validating, by a first node, the transaction and reflecting a result in the block state before the transaction is stored in the transaction pool;
generating, by a second node, a block that includes the transaction by performing validation of the transaction stored in the transaction pool; and
applying the block generated by the second node to the block state of the first node such that consistency of the blockchain network is maintained.

11. A computer readable storage medium storing one or more programs configured to be executed by one or more processors of a computing device,
wherein the one or more programs include instructions for performing a method including:
updating, by a blockchain server, a block state of a database according to a transaction when at least one transaction is received from a client;
monitoring, by a state listener, whether or not the block state is changed;
notifying, by the state listener, a worker of a function execution according to a change of the blockchain state when detecting the change of the block state; and
sending, by the worker, a transaction indicating a result of the worker executing the function to a blockchain network.
